(19) United States
(12) Patent Application Publication
(10) Pub. No.: US 2018/0304661 A1
(43) Pub. Date: Oct. 25, 2018

(54) APPARATUS FOR INSCRIBING PATTERN ON FOOD ITEM

(71) Applicant: ABI Auto-Bake Industries Ltd., Concord (CA)

(72) Inventors: Roger George Brown, Concord (CA); Eric Roger Miedema, Concord (CA); Khurram Shabbir Somjee, Concord (CA)

(73) Assignee: ABI Auto-Bake Industries Ltd., Concord (CA)

(21) Appl. No.: 15/495,651

(22) Filed: Apr. 24, 2017

(51) Int. Cl. B41M 5/24; A23P 30/00; B41M 5/00

(52) U.S. Cl. CPC B41M 5/24; B41M 5/0041; A23P 30/00

(57) ABSTRACT

An apparatus includes a positioning assembly configured to spatially position the food item relative to the memory assembly. A receiver assembly is configured to be positioned relative to the positioning assembly and the food item to be spatially positioned by the positioning assembly. An inscribing assembly is configured to be positioned relative to the positioning assembly and the food item to be spatially positioned the positioning assembly. A control assembly is configured to urge the inscribing assembly to inscribe the perceptible pattern on the food item in accordance with an image data unit corresponding to a perceptible pattern to be inscribed, at least in part, on a food item.

### TECHNICAL FIELD

This document relates to the technical field of (and is not limited to) an apparatus configured to inscribe a perceptible pattern on a food item (and method therefor), and/or a food item having a pattern inscribed thereon, in which the pattern that was inscribed on food item was inscribed by an apparatus.

### BACKGROUND

Marking of food items is generally known, such as by utilizing (A) a food package or a food container configured to receive the food item, in which the food packaging has a mark (a brand marking or an indication) that is formed on an outer surface of the food packaging, (B) a food label configured to be attached (adhered) to an outer surface of the food item, in which the food label has a mark that is formed on an outer surface of the food label, and/or (C) a mark formed directly on an outer surface of the food item, etc.

### SUMMARY

It will be appreciated that there exists a need to mitigate (at least in part) at least one problem associated with the existing systems configured to brand (mark) food items (also called the existing technology). After much study of the known systems and methods with experimentation, an understanding of the problem and its solution has been identified and is articulated as follows:

Marking of food may be accomplished, for example, by marking the food packaging (such as, with the date of food expiration, etc.). However, this practise may be prone to unauthorized (dishonest) return of stale food items (unsold foot items), in which the stale food items are placed in newer food packaging. The stale food items are returned to the retailer or the wholesaler in order to claim a refund or credit. For this case, there is no way to actually determine whether the stale food items are returned under false pretenses, which leads to higher operating costs for the food processor or manufacturer (and ultimately for the consumer).

Food packaging may provide protection, tampering resistance, present a nutrition facts label, and/or a brand indication, etc. The food packaging (with the brand indication marked thereon) is utilized for motivating consumers to purchase food items having a higher quality (or an expected quality). For instance, the brand indication may include an image, a logo, a trademark, etc., that is printed or formed on the food package, in which brand indication may enhance the perceived value of the food item to consumers.

Generic food items (of lower quality) are typically lower in cost than the brand-named food items (that have higher quality). Unscrupulous food retailers have inserted generic food items in food packaging (such as bread envelopes) as a way to deceive the public into believing they are purchasing higher priced and higher quality brand food items, which leads to degrading of the brand names associated with higher quality food items.

In view of the foregoing, what may be needed is a system and/or method that the branding of the food items is indicated directly on the food item. In this manner, the public is ensured that they are purchasing the expected food item of assured quality. In this manner, the unauthorized return of food items may be prevented (when the food item is marked with a best before date or other suitable indication). In this way, consumers may be better motivated to purchase branded food items

It may be desirable to provide an apparatus configured to apply a brand indication (an image) directly on the food item.

Preferably, it may be desirable to provide an apparatus configured to inscribe a perceptible pattern (such as a logo or an image, etc.) on a food item, and to provide a method therefor.

For instance, it may be desirable to provide an apparatus configured to inscribe or brand a logo (an image) on a food item, such as a bakery product, a bakery good or a mass-produced bakery product.

Preferably, the branding of a food item with a graphic image may be accomplished by a laser-etching system.

To mitigate, at least in part, at least one problem associated with the existing technology, there is provided (in accordance with a seventh major aspect) an apparatus. The apparatus includes and is not limited to (comprises) a positioning assembly configured to spatially position the food item relative to the memory assembly. A receiver assembly is configured to be positioned relative to the positioning assembly and the food item to be spatially positioned by the positioning assembly. An inscribing assembly is configured to be positioned relative to the positioning assembly and the food item to be spatially positioned the positioning assembly. A control assembly is configured to be operatively interfaced with the positioning assembly, the receiver assembly and the inscribing assembly. The control assembly is also configured to urge the inscribing assembly to inscribe the perceptible pattern on the food item in accordance with an image data unit corresponding to a perceptible pattern to be inscribed, at least in part, on a food item.

To mitigate, at least in part, at least one problem associated with the existing technology, there is provided (in accordance with an eighth major aspect) a food item. The food item includes and is not limited to (comprises) an outer surface. A perceptible pattern was inscribed, at least in part, on the outer surface by an apparatus. The apparatus includes a positioning assembly configured to spatially position the food item relative to the memory assembly. A receiver assembly is configured to be positioned relative to the positioning assembly and the food item to be spatially positioned by the positioning assembly. An inscribing assembly is configured to be positioned relative to the positioning assembly and the food item to be spatially positioned the positioning assembly. A control assembly is configured to be operatively interfaced with the positioning assembly, the receiver assembly and the inscribing assembly. The control assembly is also configured to urge the inscribing assembly to inscribe the perceptible pattern on the food item in accordance with an image data unit corresponding to a perceptible pattern to be inscribed, at least in part, on a food item.

To mitigate, at least in part, at least one problem associated with the existing technology, there is provided (in accordance with a ninth major aspect) an apparatus. The apparatus includes and is not limited to (comprises) a memory assembly configured to tangibly store an executable program including coded instructions configured to be readable and executable by a control assembly, and the executable program configured to urge the control assembly to perform predetermined controller operations. The memory assembly is also configured to be operatively interfaced with the control assembly. The control assembly is configured to be operatively interfaced with a positioning assembly, a receiver assembly and an inscribing assembly. The positioning assembly is configured to spatially position the food item relative to the memory assembly. The receiver assembly is configured to be positioned relative to the positioning assembly and the food item to be spatially positioned by the positioning assembly. The inscribing assembly is configured to be positioned relative to the positioning assembly and the food item to be spatially positioned the positioning assembly. The executable program is configured to urge the control assembly to urge the inscribing assembly to inscribe the perceptible pattern on the food item in accordance with an image data unit.

To mitigate, at least in part, at least one problem associated with the existing technology, there is provided (in accordance with a first major aspect) an apparatus. The apparatus includes and is not limited to (comprises) a synergistic combination of a memory assembly, a conveyor assembly, a transmitter assembly, a receiver assembly, an inscribing assembly, and a control assembly. The memory assembly is configured to tangibly store an image data unit. The image data unit corresponds to a perceptible pattern to be inscribed, at least in part, on a food item. The conveyor assembly is configured to receive and convey the food item along a direction. The transmitter assembly is configured to be positioned relative to the conveyor assembly and the food item (in which the food item is receivable and conveyable by the conveyor assembly). The receiver assembly is configured to be positioned relative to the conveyor assembly and the food item (in which the food item is receivable and conveyable by the conveyor assembly). The inscribing assembly is configured to be positioned relative to the conveyor assembly and the food item (in which the food item is receivable and conveyable by the conveyor assembly). The control assembly is configured to be operatively interfaced with the memory assembly, the conveyor assembly, the transmitter assembly, the receiver assembly and the inscribing assembly. The control assembly is also configured to urge the inscribing assembly to inscribe the perceptible pattern on the food item (in which the food item was moved by the conveyor assembly) in accordance with the image data unit and an output provided by the receiver assembly in cooperation with the transmitter assembly. In accordance with a preferred embodiment, the control assembly is also configured to execute a first operation including transmitting, to the conveyor assembly, a conveyor command. The conveyor command is configured to urge the conveyor assembly to (A) convey the food item along the direction toward an emission position, and (B) convey the food item along the direction toward an inscription position. The control assembly is also configured to execute a second operation including transmitting, to the transmitter assembly, an emission command. The emission command is configured to urge the transmitter assembly to emit an emission toward the food item positioned at the emission position (this is done in such a way that a reflected emission is reflected from the food item). The control assembly is also configured to execute a third operation including receiving, from the receiver assembly, an emission data unit. The emission data unit (in use) corresponds to the reflected emission that was received, at least in part, by the receiver assembly in response to the receiver assembly receiving, at least in part, the reflected emission that is reflected from the food item. The control assembly is also configured to execute a fourth operation including transmitting, to the inscribing assembly, an inscription command. The inscription command is configured to urge the inscribing assembly to emit an inscription emission toward the food item that is positioned at the inscription position (this is done in such a way that the inscription emission (in use) inscribes the perceptible pattern on the food item in accordance with the image data unit and the emission data unit). The food item is receivable and conveyable by the conveyor assembly.

To mitigate, at least in part, at least one problem associated with the existing technology, there is provided (in accordance with second a major aspect) an apparatus. The apparatus includes and is not limited to (comprises) a control assembly. The control assembly is configured to be operatively interfaced with a memory assembly, a conveyor assembly, a transmitter assembly, a receiver assembly and an inscribing assembly. The memory assembly is configured to tangibly store an image data unit corresponding to a perceptible pattern to be inscribed, at least in part, on a food item. The conveyor assembly is configured to receive and convey the food item along a direction. The transmitter assembly is configured to be positioned relative to the conveyor assembly and the food item that is receivable and conveyable by the conveyor assembly. The receiver assembly is configured to be positioned relative to the conveyor assembly and the food item that is receivable and conveyable by the conveyor assembly. The inscribing assembly is configured to be positioned relative to the conveyor assembly and the food item that is received by the conveyor assembly. The control assembly is also configured to urge the inscribing assembly to inscribe the perceptible pattern on the food item, in which the food item was moved by the conveyor assembly, in accordance with the image data unit and an output provided by the receiver assembly in cooperation with the transmitter assembly. In accordance with a preferred embodiment, the control assembly is further configured to execute a first operation including transmitting, to the conveyor assembly, a conveyor command configured to urge the conveyor assembly to convey the food item along the direction toward an emission position, and then to convey the food item along the direction toward an inscription position. The control assembly is further configured to execute a second operation including transmitting, to the transmitter assembly, an emission command configured to urge the transmitter assembly to emit an emission toward the food item positioned at the emission position (this is done in such a way that a reflected emission is reflected from the food item). The control assembly is further configured to execute a third operation including receiving, from the receiver assembly, an emission data unit corresponding to the reflected emission received, at least in part, by the receiver assembly in response to the receiver assembly receiving, at least in part, the reflected emission that is reflected from the food item. The control assembly is further configured to execute a fourth operation including transmitting, to the inscribing assembly, an inscription command configured to urge the inscribing assembly to emit an inscription emission toward the food item positioned at the inscription position (this is done in such a way that the inscription emission (in use) inscribes the perceptible pattern on the food item in accordance with the image data unit and the emission data unit). The food item is receivable and conveyable by the conveyor assembly

To mitigate, at least in part, at least one problem associated with the existing technology, there is provided (in accordance with a third major aspect) an apparatus. The apparatus includes and is not limited to (comprises) a memory assembly. The memory assembly is configured to be operatively interfaced with a control assembly. The control assembly is configured to be operatively interfaced with a conveyor assembly, a transmitter assembly, a receiver assembly and an inscribing assembly. The memory assembly is configured to tangibly store an image data unit corresponding to a perceptible pattern to be inscribed, at least in part, on a food item. The conveyor assembly is configured to receive and convey the food item along a direction. The transmitter assembly is configured to be positioned relative to the conveyor assembly and the food item that is receivable and conveyable by the conveyor assembly. The receiver assembly is configured to be positioned relative to the conveyor assembly and the food item that is receivable and conveyable by the conveyor assembly. The inscribing assembly is configured to be positioned relative to the conveyor assembly and the food item that is received by the conveyor assembly. The control assembly is also configured to urge the inscribing assembly to inscribe the perceptible pattern on the food item, in which the food item was moved by the conveyor assembly, in accordance with the image data unit and an output provided by the receiver assembly in cooperation with the transmitter assembly. In accordance with a preferred embodiment, the memory assembly tangibly stores (is configured to store) an executable program. The executable program includes coded instructions configured to be readable by, and executable by, the control assembly. The executable program is also configured to urge the control assembly to perform a first operation, a second operation, a third operation and a fourth operation, etc. The first operation includes instructing the control assembly to transmit, to the conveyor assembly, a conveyor command configured to urge the conveyor assembly to convey the food item along the direction toward an emission position, and then to convey the food item along the direction toward an inscription position. The first operation includes instructing the control assembly to transmit, to the transmitter assembly, an emission command configured to urge the transmitter assembly to emit an emission toward the food item positioned at the emission position (this is done in such a way that a reflected emission is reflected from the food item). The first operation includes instructing the control assembly to receive, from the receiver assembly, an emission data unit corresponding to the reflected emission received, at least in part, by the receiver assembly in response to the receiver assembly receiving, at least in part, the reflected emission that is reflected from the food item. The first operation includes instructing the control assembly to transmit, to the inscribing assembly, an inscription command configured to urge the inscribing assembly to emit an inscription emission toward the food item positioned at the inscription position (this is done in such a way that the inscription emission (in use) inscribes the perceptible pattern on the food item in accordance with the image data unit and the emission data unit). The food item is receivable and conveyable by the conveyor assembly.

To mitigate, at least in part, at least one problem associated with the existing technology, there is provided (in accordance with a fourth major aspect) a method. The method is for operating an apparatus. The apparatus includes a synergistic combination of a memory assembly, a conveyor assembly, a transmitter assembly, a receiver assembly, and an inscribing assembly. The memory assembly is configured to tangibly store an image data unit corresponding to a perceptible pattern to be inscribed, at least in part, on a food item. The conveyor assembly is configured to receive and convey the food item along a direction. The transmitter assembly is configured to be positioned relative to the conveyor assembly and the food item that is receivable and conveyable by the conveyor assembly. The receiver assembly is configured to be positioned relative to the conveyor assembly and the food item that is receivable and conveyable by the conveyor assembly. The inscribing assembly is configured to be positioned relative to the conveyor assembly and the food item that is received by the conveyor assembly.

The method comprises (includes the steps of) transmitting, to the conveyor assembly, a conveyor command configured to urge the conveyor assembly to convey the food item along the direction toward an emission position, and then to convey the food item along the direction toward an inscription position.

In accordance with an embodiment, the method further comprises (includes) transmitting, to the transmitter assembly, an emission command configured to urge the transmitter assembly to emit an emission toward the food item positioned at the emission position (this is done in such a way that a reflected emission is reflected from the food item).

In accordance with an embodiment, the method further comprises (includes) receiving, from the receiver assembly, an emission data unit corresponding to the reflected emission received, at least in part, by the receiver assembly in response to the receiver assembly receiving, at least in part, the reflected emission that is reflected from the food item.

In accordance with an embodiment, the method further comprises (includes) transmitting, to the inscribing assembly, an inscription command configured to urge the inscribing assembly to emit an inscription emission toward the food item positioned at the inscription position (this is done in such a way that the inscription emission (in use) inscribes the perceptible pattern on the food item in accordance with the image data unit and the emission data unit). The food item is receivable and conveyable by the conveyor assembly.

In accordance with a fifth major aspect, there is provided a food item made by any apparatus as described above. The food item has an outer surface defining a perceptible pattern that was inscribed at least in part, thereon, by the apparatus. The apparatus includes and is not limited to (comprises) a synergistic combination of a memory assembly, a conveyor assembly, a transmitter assembly, a receiver assembly, an inscribing assembly, and a control assembly. The memory assembly is configured to tangibly store an image data unit corresponding to the perceptible pattern to be inscribed, at least in part, on the food item. The conveyor assembly is configured to receive and convey the food item along a direction. The transmitter assembly is configured to be positioned relative to the conveyor assembly and the food item that is receivable and conveyable by the conveyor assembly. The receiver assembly is configured to be positioned relative to the conveyor assembly and the food item that is receivable and conveyable by the conveyor assembly. The inscribing assembly is configured to be positioned relative to the conveyor assembly and the food item that is received by the conveyor assembly. The control assembly is configured to be operatively interfaced with the memory assembly, the conveyor assembly, the transmitter assembly, the receiver assembly and the inscribing assembly. The control assembly is also configured to urge the inscribing assembly to inscribe the perceptible pattern on the food item, in which the food item was moved by the conveyor assembly, in accordance with the image data unit and an output provided by the receiver assembly in cooperation with the transmitter assembly. In accordance with a preferred embodiment, the control assembly is also configured to execute a first operation including transmitting, to the conveyor assembly, a conveyor command configured to urge the conveyor assembly to convey the food item along the direction toward an emission position, and then to convey the food item along the direction toward an inscription position. The control assembly is also configured to execute a second operation including transmitting, to the transmitter assembly, an emission command configured to urge the transmitter assembly to emit an emission toward the food item positioned at the emission position (this is done in such a way that a reflected emission is reflected from the food item). The control assembly is also configured to execute a third operation including receiving, from the receiver assembly, an emission data unit. The emission data unit (in use) corresponds to the reflected emission that was received, at least in part, by the receiver assembly (in response to the receiver assembly receiving, at least in part, the reflected emission that is reflected from the food item). The control assembly is also configured to execute a fourth operation including transmitting, to the inscribing assembly, an inscription command configured to urge the inscribing assembly to emit an inscription emission toward the food item positioned at the inscription position (this is done in such a way that the inscription emission (in use) inscribes the perceptible pattern on the food item in accordance with the image data unit and the emission data unit). The food item is receivable and conveyable by the conveyor assembly.

To mitigate, at least in part, at least one problem associated with the existing technology, there is provided (in accordance with a sixth major aspect) a method. The method is for inscribing, at least in part, on an outer surface a food item by an apparatus. The apparatus includes a synergistic combination of a memory assembly, a conveyor assembly, a transmitter assembly, a receiver assembly, and an inscribing assembly. The memory assembly is configured to tangibly store an image data unit corresponding to a perceptible pattern to be inscribed, at least in part, on a food item. The conveyor assembly is configured to receive and convey the food item along a direction. The transmitter assembly is configured to be positioned relative to the conveyor assembly and the food item that is receivable and conveyable by the conveyor assembly. The receiver assembly is configured to be positioned relative to the conveyor assembly and the food item that is receivable and conveyable by the conveyor assembly. The inscribing assembly is configured to be positioned relative to the conveyor assembly and the food item that is received by the conveyor assembly.

The method comprises (includes the steps of) transmitting, to the conveyor assembly, a conveyor command configured to urge the conveyor assembly to convey the food item along the direction toward an emission position, and then to convey the food item along the direction toward an inscription position.

In accordance with an embodiment, the method further comprises (includes) transmitting, to the transmitter assembly, an emission command configured to urge the transmitter assembly to emit an emission toward the food item positioned at the emission position (this is done in such a way that a reflected emission is reflected from the food item).

In accordance with an embodiment, the method further comprises (includes) receiving, from the receiver assembly, an emission data unit corresponding to the reflected emission received, at least in part, by the receiver assembly in response to the receiver assembly receiving, at least in part, the reflected emission that is reflected from the food item.

In accordance with an embodiment, the method further comprises (includes) transmitting, to the inscribing assembly, an inscription command configured to urge the inscribing assembly to emit an inscription emission toward the food item positioned at the inscription position (this is done in such a way that the inscription emission (in use) inscribes the perceptible pattern on the food item in accordance with the image data unit and the emission data unit). The food item is receivable and conveyable by the conveyor assembly.

Other aspects are identified in the claims. Other aspects and features of the non-limiting embodiments may now become apparent to those skilled in the art upon review of the following detailed description of the non-limiting embodiments with the accompanying drawings. This Summary is provided to introduce concepts in simplified form that are further described below in the Detailed Description. This Summary is not intended to identify key features or essential features of the disclosed subject matter, and is not intended to describe each disclosed embodiment or every implementation of the disclosed subject matter. Many other novel advantages, features, and relationships will become apparent as this description proceeds. The figures (FIGS.) and the description that follow more particularly exemplify illustrative embodiments.

### BRIEF DESCRIPTION OF THE DRAWINGS

The non-limiting embodiments may be more fully appreciated by reference to the following detailed description of the non-limiting embodiments when taken in conjunction with the accompanying drawings, in which:

FIG. 1 depicts a schematic view of an embodiment of an apparatus configured to inscribe a perceptible pattern on a food item; and

FIGS. 2 and 3 depict schematic views of embodiments of the operations of the apparatus of FIG. 1; and

FIG. 4 depicts a perspective view of an embodiment of the food item having the perceptible pattern of FIG. 1; and

FIG. 5 depicts a first perspective view of an embodiment of the apparatus of FIG. 1; and

FIG. 6 depicts a second perspective view of an embodiment of the apparatus of FIG. 5; and

FIG. 7 depicts a top view of an embodiment of the apparatus of FIG. 5; and

FIGS. 8 and 9 depict side views of embodiments of the apparatus of FIG. 5; and

FIGS. 10 and 11 depict end views of embodiments of the apparatus of FIG. 5; and

FIGS. 12, 13 and 14 depict schematic views of embodiments of the apparatus of FIG. 1.

The drawings are not necessarily to scale and may be illustrated by phantom lines, diagrammatic representations and fragmentary views. In certain instances, details unnecessary for an understanding of the embodiments (and/or details that render other details difficult to perceive) may have been omitted. Corresponding reference characters indicate corresponding components throughout the several figures of the drawings. Elements in the several figures are illustrated for simplicity and clarity and have not been drawn to scale. The dimensions of some of the elements in the figures may be emphasized relative to other elements for facilitating an understanding of the various disclosed embodiments. In addition, common, but well-understood, elements that are useful or necessary in commercially feasible embodiments are often not depicted to provide a less obstructed view of the embodiments of the present disclosure.

### LISTING OF REFERENCE NUMERALS USED IN THE DRAWINGS

100 apparatus
102 control assembly
104 memory assembly
106 image data unit
108 executable program
110 laser-scanner system
112 camera system
114 laser-inscribing system
116 encoder device
199 positioning assembly
201 direction
202 conveyor assembly
202A first conveyor assembly
202B second conveyor assembly
203 controllable movement element
204A first transmitter assembly
204B second transmitter assembly
204 transmitter assembly
205 position-recording assembly
205A first position-recording assembly
205B second position-recording assembly
206 receiver assembly
206A first receiver assembly
206B second receiver assembly
207 conveyor motor assembly
207A first conveyor motor assembly
207B second conveyor motor assembly
208 inscribing assembly
208A first inscribing assembly
208B second inscribing assembly
209 position data unit
302 smoke-extraction assembly
303 blower assembly
304 galvanometer head
306 laser-source assembly
308 field of view (FOV)
310 accumulation assembly
312 height-adjustment assembly
314 gear-motor assembly
316 user-control assembly
402 first operation
404 second operation
405 operation
406 third operation
408 fourth operation
504 emission zone
508 inscription zone
604 emission
606 reflected emission
608 inscription emission
706 emission data unit
802 conveyor command
804 emission command
806 receiving command
808 inscription command
900 food item
901 outer surface
902 perceptible pattern

### DETAILED DESCRIPTION OF THE NON-LIMITING EMBODIMENT(S)

The following detailed description is merely exemplary and is not intended to limit the described embodiments or the application and uses of the described embodiments. As used, the word “exemplary” or “illustrative” means “serving as an example, instance, or illustration.” Any implementation described as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure. The scope of may be defined by the claims (in which the claims may be amended during patent examination after filing of this application). For the description, the terms “upper,” “lower,” “left,” “rear,” “right,” “front,” “vertical,” “horizontal,” and derivatives thereof shall relate to the examples as oriented in the drawings. There is no intention to be bound by any expressed or implied theory in the preceding Technical Field, Background, Summary or the following detailed description. It is also to be understood that the devices and processes illustrated in the attached drawings, and described in the following specification, are exemplary embodiments (examples), aspects and/or concepts defined in the appended claims. Hence, dimensions and other physical characteristics relating to the embodiments disclosed are not to be considered as limiting, unless the claims expressly state otherwise. It is understood that the phrase “at least one” is equivalent to “a”. The aspects (examples, alterations, modifications, options, variations, embodiments and any equivalent thereof) are described regarding the drawings. It should be understood that the invention is limited to the subject matter provided by the claims, and that the invention is not limited to the particular aspects depicted and described. It will be appreciated that, for instance, the scope of the meaning of a device configured to be coupled (connected, interact, etc.) to an item is to be interpreted as the device is configured to be coupled (connected, interact, etc.), either directly or indirectly, to the item. Therefore, “configured to” may include the meaning “either directly or indirectly” unless specifically stated otherwise.

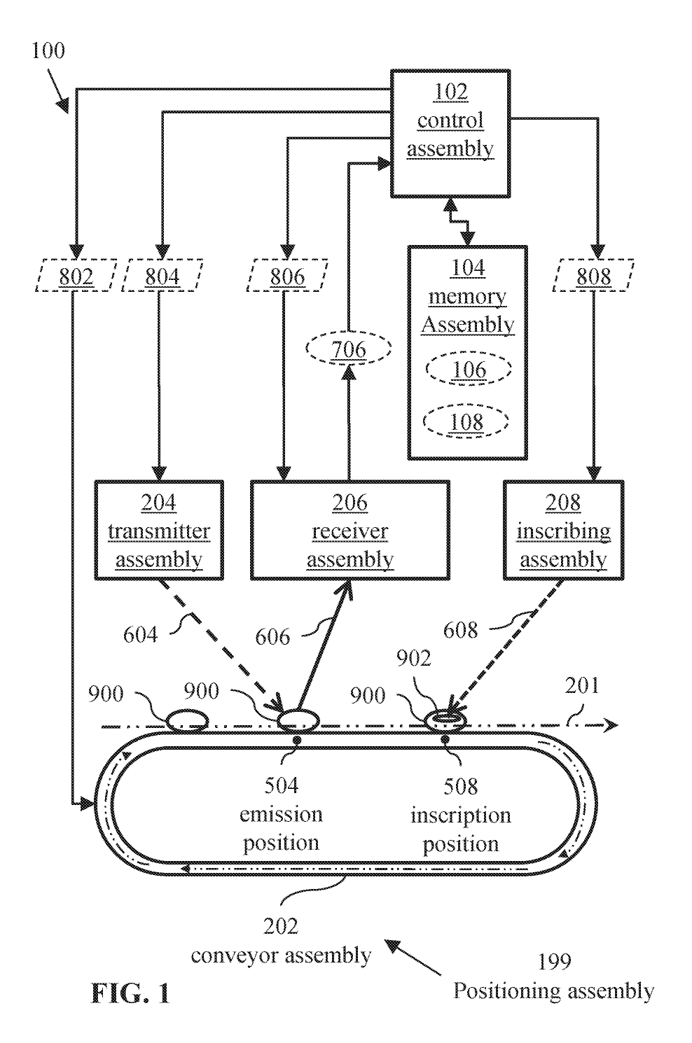

FIG. 1 depicts a schematic view of an embodiment of an apparatus 100 configured to inscribe a perceptible pattern 902 on a food item 900.

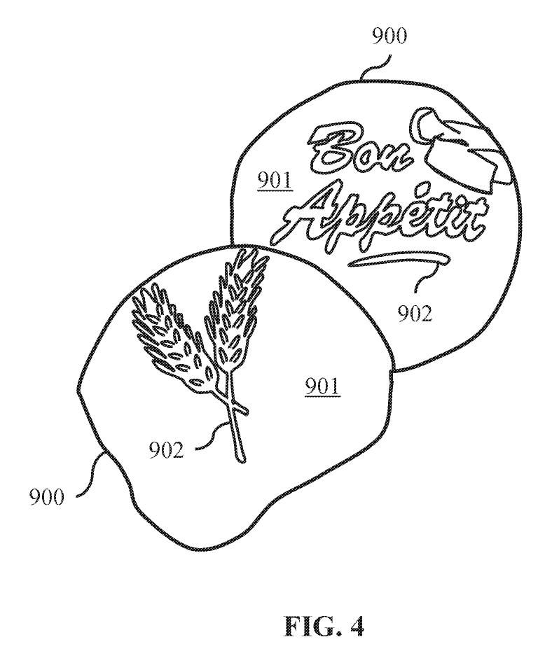

An embodiment of the food item 900 is depicted in FIG. 4. The food item 900 includes or has an outer surface 901 (also called an exterior surface). The perceptible pattern 902 is inscribed on the outer surface 901. The food item 900 may include any type of food item that is consumable by a person (or an animal). The food item 900 may include (for instance) a fresh food product, a food product, a baked good, a bakery product, a cooked food item, an uncooked food item, a partially cooked food item, a prepared food item, a semi-prepared food item, an unprepared food item, etc.

An embodiment of the perceptible pattern 902 is depicted in FIG. 4. The perceptible pattern 902 may be called a visually-perceptible pattern, etc., and any equivalent thereof. The perceptible pattern 902 may include any type of image, formation or relief pattern to be inscribed (formed) on the food item 900. It will be appreciated that the process for inscribing the perceptible pattern 902 may include (and is not limited to) laser inscribing and/or laser cutting, etc.

In accordance with the embodiment as depicted in FIG. 1, the apparatus 100 includes (and is not limited to) a control assembly 102.

In accordance with a first major aspect, the apparatus 100 includes and is not limited to (comprises) a synergistic combination of a memory assembly 104, a positioning assembly 199 (such as, a conveyor assembly 202, a pick- and place robot, etc.), a transmitter assembly 204, a receiver assembly 206, an inscribing assembly 208, and a control assembly 102.

In accordance with a second major aspect, the apparatus 100 includes and is not limited to (comprises) a control assembly 102. The control assembly 102 is configured to cooperate with (operatively interface with) a synergistic combination of a memory assembly 104, a positioning assembly 199 (such as, a conveyor assembly 202, etc.), a transmitter assembly 204, a receiver assembly 206, and an inscribing assembly 208.

In accordance with a third major aspect, the apparatus 100 includes and is not limited to (comprises) a memory assembly 104. The memory assembly 104 is configured to cooperate with (operatively interface with) a synergistic combination of a positioning assembly 199 (such as, a conveyor assembly 202, etc.), a transmitter assembly 204, a receiver assembly 206, an inscribing assembly 208, and a control assembly 102.

Other major aspects are identified in the Summary section and/or in the Claims section.

The control assembly 102, for instance, may include a computer system (industrialized computer system), a programmable logic controller (PLC), a programmable controller, and any equivalent thereof. Preferably, the control assembly 102 includes an industrialized digital computer which has been ruggedized and adapted for the control of a manufacturing process suitable for relatively harsh environments, such as a food processing and assembly line, or any activity that requires, for instance, relatively higher reliability control and relative ease of programming and process-fault diagnosis. Preferably, the control assembly 102 is configured to produce (provide) output results within a limited time and with sufficient speed of operation to respond to input conditions (otherwise unintended operation may result). In accordance with a preferred embodiment, the control assembly 102 includes a WINDOWS (TRADEMARK) based computer (and any equivalent thereof) having an executable application (custom software written). The WINDOWS (TRADEMARK) operating system is manufactured and/or supplied by MICROSOFT (TRADEMARK) headquartered in Washington, U.S.A.

Referring to the preferred embodiment as depicted in FIG. 1, the control assembly 102 is configured to be operatively interfaced with a memory assembly 104, a positioning assembly 199 (such as, a conveyor assembly 202, etc.), a transmitter assembly 204, a receiver assembly 206 and an inscribing assembly 208.

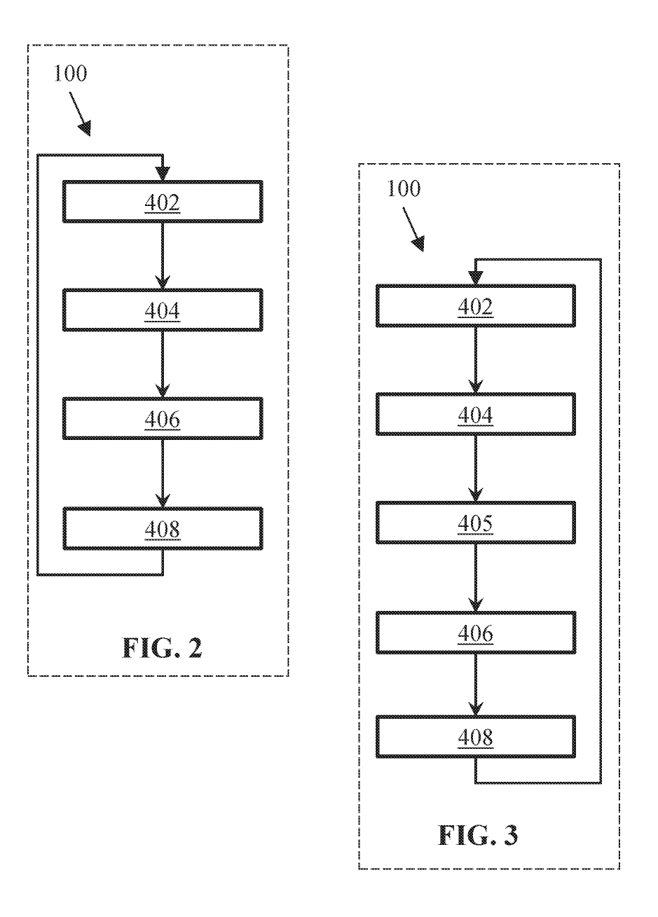

Referring to the preferred embodiment as depicted in FIG. 1, the memory assembly 104 is configured to receive and tangibly store an executable program 108. The executable program 108 includes coded instructions (programmed coded instructions) configured to be readable and executable by the control assembly 102. The executable program 108 is configured to urge the control assembly 102 to perform predetermined controller operations, such as the first operation 402, the second operation 404, the third operation 406 and the fourth operation 408 (operations are depicted in the schematic embodiments depicted in FIG. 2 and FIG. 3).

It will be appreciated that an equivalent to the executable program 108 includes (and is not limited to) (A) machine-language code, (B) assembly-language based code, and/or (C) source code formed in a high-level computing language more easily understood by humans, and any equivalent thereof. The high-level language of the source code is compiled into either an executable machine code file or a non-executable machine-code object file. An equivalent to the executable program 108 may also include (A) an application-specific integrated circuit configured to operate in accordance with the operations of the control assembly 102 as directed by the executable program 108 and any equivalent thereof, and (B) a field-programmable gate array (FPGA) and any equivalent thereof.

The memory assembly 104 is configured to tangibly store an image data unit 106 corresponding to a perceptible pattern 902 to be inscribed, at least in part, on a food item 900. The memory assembly 104 may be built into the control assembly 102 or may be connectable to the control assembly 102.

Preferably, the memory assembly 104 includes any type of computer-readable media or computer-hardware device configured to receive and tangibly store information (digital information) to be utilized by the control assembly 102. The memory assembly 104 may include random-access memory (RAM) or virtual memory. Virtual memory is memory that appears to exist as main storage although most of it is supported by data held in secondary storage, in which transfer between the two types of memory is made automatically, as required. The memory assembly 104 may be associated with addressable semiconductor memory (i.e., integrated circuits including silicon-based transistors) used, for example, as primary storage or main storage. The memory assembly 104 may include volatile memory and non-volatile memory. Examples of non-volatile memory are flash memory (used as secondary memory), ROM (Read Only Memory), PROM (Programmable Read Only Memory), EPROM (Electrically Programmable Read Only Memory) and/or EEPROM (Electrically Erasable and Programmable Read Only Memory) used for storing firmware such as BIOS, etc., and in any combination and permutation thereof. Examples of volatile memory are primary storage, which may be dynamic random-access memory (DRAM), and fast CPU (Central Processing Unit) cache memory, static random-access memory (SRAM), etc., and in any combination and permutation thereof.

Preferably, the image data unit 106 includes any type of recorded image (such as, a digital computer file) configured to represent (correspond to) the perceptible pattern 902 to be inscribed (formed) on the food item 900. For instance, the image data unit 106 may include any type of digital computer file (such as a JPEG file), which is configured to represent an image (such as a chef's hat, etc.). For instance, JPEG (Joint Photographic Experts Group) provides a method of compression for a digital image, particularly for those images produced by digital photography. The degree of compression may be adjusted, allowing a selectable trade-off between storage size and image quality. For instance, JPEG may achieve 10:1 compression with little perceptible loss in image quality.

Preferably, the positioning assembly 199 is configured to spatially position (such as, orient, locate, etc.) the food item 900 relative to the memory assembly 104 and/or relative to the control assembly 102. Preferably (in accordance with a preferred embodiment), the positioning assembly 199 includes (and is not limited to) a conveyor assembly 202. The conveyor assembly 202 is configured to receive and convey the food item 900 along a direction 201. The conveyor assembly 202 is configured to move the food item 900 from one location to another. The conveyor assembly 202 may be called a transfer conveyor, a mechanical-handling equipment, etc., and any equivalent thereof. The conveyor assembly 202 may include any type of conveying system, such as a chain conveyor, a belt conveyor, etc., and any equivalent thereof. In accordance with a preferred embodiment, the conveyor assembly 202 includes the ABI (TRADEMARK) MODEL number COMB00001 conveyor (and any equivalent thereof), and is manufactured and/or supplied by ABI Limited headquartered in Ontario, Canada.

The transmitter assembly 204 is configured to be positioned (located) relative to the conveyor assembly 202 and the food item 900 (the food item 900 is receivable and conveyable by the conveyor assembly 202). The transmitter assembly 204 is configured to transmit (emit, cast, etc., either directly or indirectly) an emission 604 (such as an electromagnetic emission, etc., and any equivalent thereof), in which the emission 604 is to be received, at least in part, by the food item 900. For instance, the emission 604 may include an electromagnetic emission, etc., and any equivalent thereof. The transmitter assembly 204 may be called an emission source, an electromagnetic-emission source, etc., and any equivalent thereof. The electromagnetic-emission source is configured to emit (transmit, cast, broadcast, etc.) an electromagnetic-emission, such as a laser light, an infrared light, an ultrasound signal, etc., and any equivalent thereof. The transmitter assembly 204 may include a laser scanner, etc., and any equivalent thereof.

The receiver assembly 206 is configured to be positioned relative to the conveyor assembly 202 and the food item 900 (the food item 900 is receivable and conveyable by the conveyor assembly 202). The receiver assembly 206 may be called a vision system, etc., and any equivalent thereof. For instance, the receiver assembly 206 may include a detector, a sensor, an electromagnetic-emission detector, a camera, etc., and any equivalent thereof. The receiver assembly 206 is configured to obtain (capture, receive) information or an image. The receiver assembly 206 may include, for instance, a two dimensional camera, three dimensional laser scanner, etc. Preferably, the receiver assembly 206 includes any one of (or a combination of) a camera system 112, a radar system, a sonar system, an infrared sensor, a proximity sensor, a laser-scanner assembly, etc., and any equivalent thereof. The receiver assembly 206 is configured to receive (detect), at least in part, a reflected emission 606 that is reflected, at least in part, from the food item 900 (preferably, from an emission zone 504). The reflected emission 606 includes some amount of the emission 604 that was reflected from an outer surface of the food item 900. The emission 604 may include, for instance, an electromagnetic emission, a laser emission, etc., and any equivalent thereof. The emission 604, in use, is directed toward the food item 900. The emission 604 is emitted (provided) by the transmitter assembly 204, etc. (and any equivalent thereof) toward the food item. In accordance with a preferred embodiment, the receiver assembly 206 includes a laser-scanner assembly configured to scan for a laser light that was reflected from the food item 900. In accordance with a preferred embodiment, the transmitter assembly 204 and the receiver assembly 206 are included (incorporated) in a single system, such as the HERMARY (TRADEMARK) MODEL number SL-1880 vision system (and any equivalent thereof), and is manufactured and/or supplied by HERMARY MACHINE VISION headquartered in British Columbia, Canada.

The inscribing assembly 208 is configured to be positioned relative to the conveyor assembly 202 and the food item 900 (the food item 900 is received by the conveyor assembly 202). The inscribing assembly 208 is configured to inscribe the perceptible pattern 902 on the food item 900. The inscribing assembly 208 may include a laser-inscribing system 114 (which may be called a laser cutting system) configured to emit a laser light (of sufficient strength or intensity, etc., and any equivalent thereof) toward the food item 900. In accordance with a preferred embodiment, the inscribing assembly 208 includes the SYNRAD (TRADEMARK) MODEL number FSTi100SFB FIRESTAR (TRADEMARK) laser (and any equivalent thereof), and is manufactured and/or supplied by SYNRAD headquartered in Washington, U.S.A.

FIGS. 2 and 3 depict schematic views of embodiments of the operations of the apparatus 100 of FIG. 1.

Referring to the embodiment as depicted in FIG. 2, the control assembly 102 is configured to execute a first operation 402. The first operation 402 includes transmitting, to the conveyor assembly 202, a conveyor command 802. The conveyor command 802 is configured to urge the conveyor assembly 202 to convey the food item 900 along, at least in part, the direction 201 toward an emission zone 504, and then to convey the food item 900 along, at least in part, the direction 201 toward an inscription zone 508. Once the first operation 402 is completed, operational control is transferred to the second operation 404.

Referring to the embodiment as depicted in FIG. 2, the control assembly 102 is also configured to execute a second operation 404. The second operation 404 includes transmitting, to the transmitter assembly 204, an emission command 804. The emission command 804 is configured to urge the transmitter assembly 204 to emit an emission 604 toward the food item 900 that is positioned at the emission zone 504. This is done in such a way that a reflected emission 606 is reflected, at least in part, from the food item 900 (preferably, at the emission zone 504). Preferably, the conveyor assembly 202, in use, conveyed the food item 900 toward the emission zone 504. Once the second operation 404 is completed, operational control is transferred to the third operation 406 (as depicted in FIG. 2). In accordance with a preferred embodiment (as depicted in FIG. 3), once the second operation 404 is completed, operational control is transferred to an optional operation 405.

Referring to the preferred (optional) embodiment as depicted in FIG. 3, before the third operation 406 is executed, the control assembly 102 is also configured to execute an optional operation 405. The optional operation 405 includes transmitting, to the receiver assembly 206, a receiving command 806. The receiving command 806 is configured to urge the receiver assembly 206 to receive, at least in part, the reflected emission 606 that is reflected, at least in part, from the food item 900. Once the optional operation 405 is completed, operational control is transferred to the third operation 406.

Referring to the embodiment as depicted in FIG. 2, the control assembly 102 is also configured to execute a third operation 406. The third operation 406 includes receiving, from the receiver assembly 206, an emission data unit 706. The emission data unit 706 corresponds to the reflected emission 606 that was received, at least in part, by the receiver assembly 206 (in response to the receiver assembly 206 receiving, at least in part, the reflected emission 606 that is reflected from the food item 900). Preferably, the reflected emission 606 is reflected, at least in part, from the food item 900 at the emission zone 504. Once the third operation 406 is completed, operational control is transferred to the fourth operation 408.

Referring to the embodiment as depicted in FIG. 2, the control assembly 102 is also configured to execute a fourth operation 408. The fourth operation 408 includes transmitting, to the inscribing assembly 208, an inscription command 808. The inscription command 808 is configured to urge the inscribing assembly 208 to emit an inscription emission 608 toward the food item 900 that is positioned at the inscription zone 508. This is done in such a way that the inscription emission 608 (in use) inscribes, at least in part, the perceptible pattern 902 on the food item 900 (in which the food item 900 is receivable and conveyable by the conveyor assembly 202) in accordance with the image data unit 106 (that is stored in the memory assembly 104) and the emission data unit 706 (that is provided by the receiver assembly 206). Preferably, the conveyor assembly 202, in use, conveyed the food item 900 toward the inscription zone 508.

FIG. 4 depicts a perspective view of an embodiment of the food item 900 having the perceptible pattern 902 of FIG. 1.

Referring to the embodiment as depicted in FIG. 4, the perceptible pattern 902 may include any type of image, formation or relief pattern (such as an image of a stalk of wheat or a chef's hat) to be inscribed (formed) on the food item 900. The food item 900 may include any type of food item (such as a bun, etc.) that is consumable by a person.

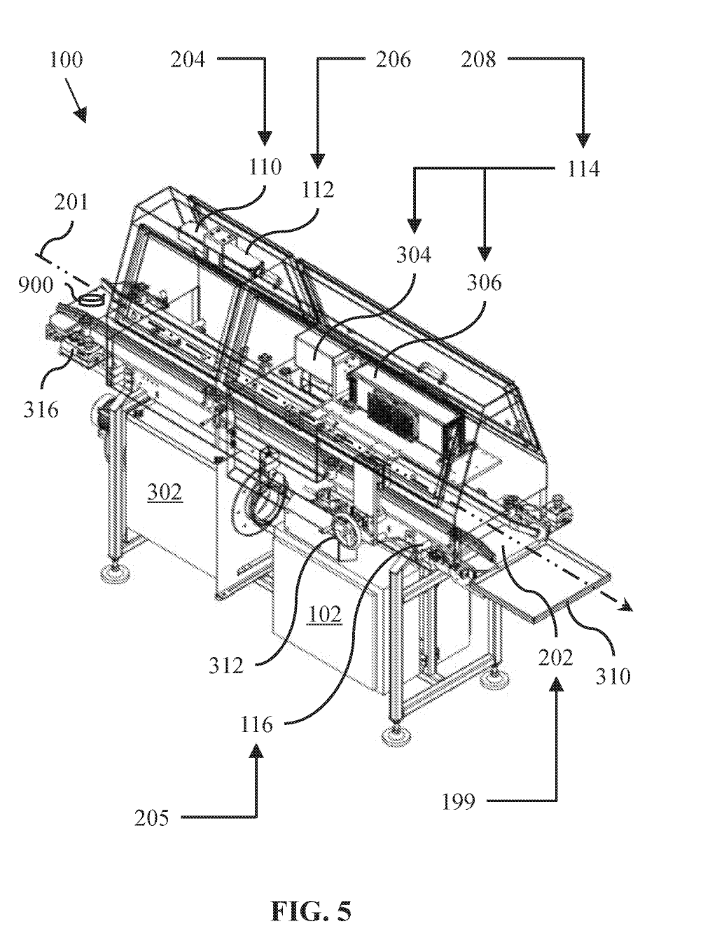

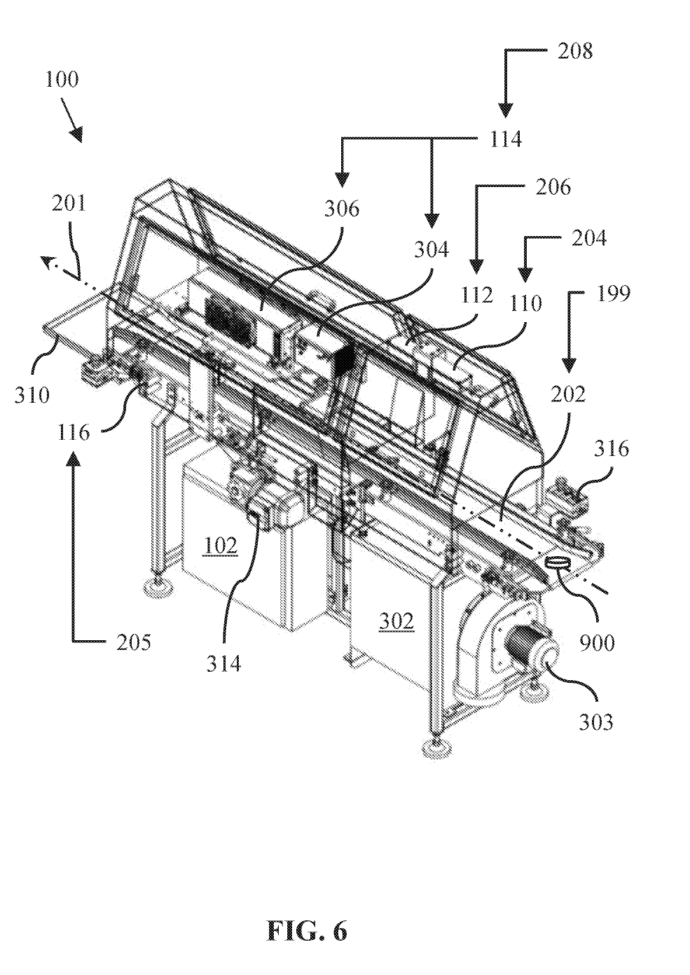

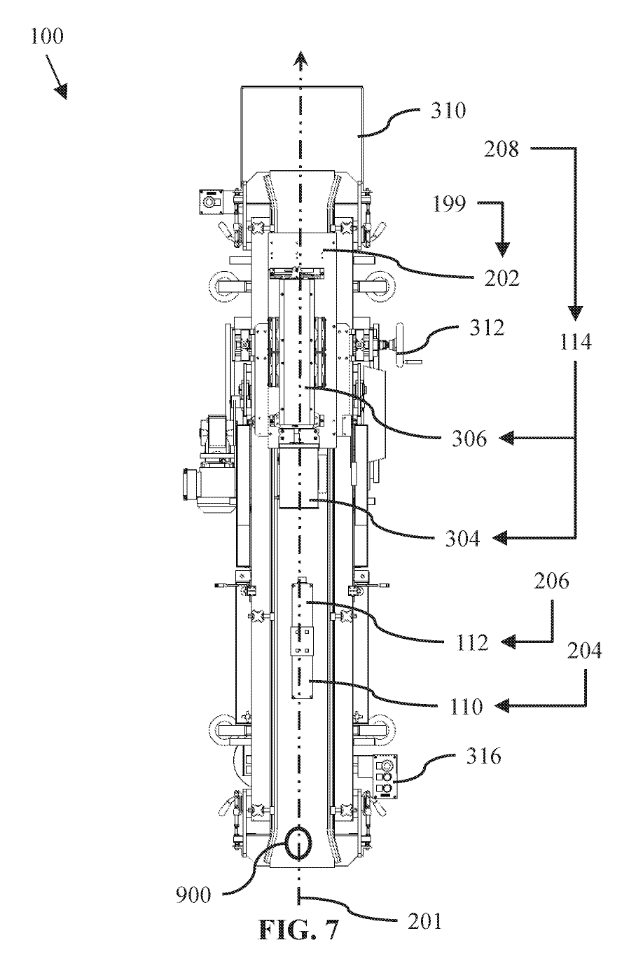

FIG. 5 depicts a first perspective view of an embodiment of the apparatus 100 of FIG. 1. FIG. 6 depicts a second perspective view of an embodiment of the apparatus 100 of FIG. 5. FIG. 7 depicts a top view of an embodiment of the apparatus 100 of FIG. 5.

Referring to the embodiment as depicted in FIG. 5 (in accordance with a preferred embodiment), the inscribing assembly 208 does not burn the food item 900 once the inscribing assembly 208, in use, inscribes the outer surface 901 onto the food item 900. Preferably, the food item 900 may include (and is not limited to) uncooked dough that does not become burned by the inscribing assembly 208. It will be appreciated that in some cases, the inscribing assembly 208 may be permitted to burn, to a reasonable safe degree, the food item (if necessary), for the case where is not altogether possible to avoid burning of the food item 900).

In accordance with a preferred embodiment, the food item 900 is positioned (placed, located) in a food pan (known and not depicted). The food pan is positioned (placed, located) on the conveyor assembly 202. For this case, the position and/or location of the food item 900 is known once the food item 900 is received in the food pan, and the food pan is placed on the conveyor assembly 202 (since the position of the food pan may be determined relative to a reference position on the conveyor assembly 202).

In accordance with an embodiment, the apparatus 100 is adapted in such a way that the conveyor assembly 202 includes a position-recording assembly 205. The position-recording assembly 205 is configured to record (encode) the position information of the conveyor assembly 202. In accordance with a preferred embodiment, the encoder device 116 includes the BAUMER (TRADEMARK) MODEL number HS35 encoder (and any equivalent thereof), and is manufactured and/or supplied by BAUMER Limited headquartered in Connecticut, U.S.A.

In accordance with an embodiment, the apparatus 100 is adapted in such a way that the transmitter assembly 204 includes a laser-scanner system 110, and the receiver assembly 206 includes a camera system 112. In accordance with a preferred embodiment, the laser-scanner system 110 and the camera system 112 are included (incorporated) in a single system, such as the HERMARY (TRADEMARK) MODEL number SL-1880 vision system (and any equivalent thereof), and is manufactured and/or supplied by HERMARY MACHINE VISION headquartered in British Columbia, Canada.

In accordance with an embodiment, the apparatus 100 is adapted in such a way that the inscribing assembly 208 includes a laser-inscribing system 114. The laser-inscribing system 114 includes a laser-source assembly 306 and a galvanometer head 304. In accordance with a preferred embodiment, the laser-source assembly 306 includes the SYNRAD (TRADEMARK) MODEL number FSTi100SFB FIRESTAR (TRADEMARK) laser (and any equivalent thereof), and is manufactured and/or supplied by SYNRAD headquartered in Washington, U.S.A. In accordance with a preferred embodiment, the galvanometer head 304 includes the SYNRAD (TRADEMARK) MODEL number FHFL50-200 FH FLYER (TRADEMARK) galvanometer head (and any equivalent thereof), and is manufactured and/or supplied by SYNRAD headquartered in Washington, U.S.A. The laser-inscribing system 114 may be called a laser projector, etc., and any equivalent thereof. The laser-inscribing system 114 is configured to project a laser beam on the food item to create an image to be burned onto the food item 900. The laser-inscribing system 114 includes laser devices, mirrors, the galvanometer head 304 (also called a galvanometer scanner, etc., and any equivalent thereof), and other optical components and/or assemblies. The laser-inscribing system 114 may include one of more laser light sources (if desired). The galvanometer head 304 (also called galvanometers, scanners, galvos, etc., and any equivalent thereof) is configured to be a computer controllable electromagnetic device. The galvanometer head 304 is configured to move mirrors mounted on the end of rotary shafts. The mirror reflects the laser beam to draw images. The galvanometer head 304 may be configured to move at least one or more beams (laser beams) in at least one or more planes, either the X axis and/or the Y axis, etc. It will be appreciated that several instances of the galvanometer head 304 may be utilized (if so desired). The galvanometer head 304 may be open loop or closed loop controllable. Closed loop means the galvanometer head 304 is controllable by a servo system (the control circuit uses a feedback signal generated by the mirror's motion to correct motion commands).

Preferably, the food item 900 is positioned (placed, located) on the conveyor assembly 202. For this case, the position and/or location of the food item 900 is unknown (relative to the conveyor assembly 202) once the food item 900 is placed on the conveyor assembly 202. For this case, the camera system 112 is configured to assist in the determination of the position and the orientation of the food item 900 relative to the conveyor assembly 202 (once the food item 900 is placed on the conveyor assembly 202, and the conveyor assembly 202 moves the food item 900 relative to the camera system 112). The laser-scanner system 110 is configured to emit (scan) a laser light (a line of laser light) onto the food item 900 as the conveyor assembly 202 moves the food item 900 past the laser-scanner system 110. The camera system 112 is configured to capture (scan or receive) an image of the food item 900 that shows the orientation and the position of the food item 900 relative to the conveyor assembly 202. The control assembly 102 is configured to receive, from the encoder device 116, the position of the food item 900 that is received by the conveyor assembly 202 once the camera system 112, in use, captures the image of the food item 900. The camera system 112 is configured to detect the presence (position and orientation) of the food item 900. The laser-inscribing system 114 is configured to emit a graphic image onto a target surface of the food item 900 once the conveyor assembly 202 has moved the food item 900 proximate to the laser-inscribing system 114. It will be appreciated that the position of the food item 900 relative to the laser-inscribing system 114 may be determined by the control assembly 102 by computing the speed of travel in conjunction with travel time of the food item 900 (which is being moved by the conveyor assembly 202) or the position of the food item 900 as indicated by the encoder device 116 once the camera system 112, in use, captures the image of the food item 900. Preferably, the control assembly 102, in use, transmits the image (to be inscribed to the food item 900) to the galvanometer head 304. The galvanometer head 304 is configured to emit (transmit) the graphic to the surface of the food item 900. The laser-inscribing system 114 is configured to imprint the image onto the food item 900 based on the information provided by the camera system 112 (the camera system 112, in use, detects the presence (position and orientation) of the food item 900). The galvanometer head 304 of the laser-inscribing system 114 is configured to change position of a mirror so that the laser light (laser beam) is placed onto a desired spot on the food item 900. The galvanometer head 304 may be configured to operate in a 2D axis (if so desired). The galvanometer head 304 may be configured to operate in a 1D axis with assistance from a positioning device (configured to move the food item 900), etc. The galvanometer head 304 includes mirrors configured to be movable (so that the mirrors, in operation, move the position and/or orientation of the laser beam that is received on the food item 900). The laser-source assembly 306 may be water cooled or air cooled, etc.

In accordance with a preferred embodiment, the apparatus 100 further includes a height-adjustment assembly 312 configured to adjust the height of the galvanometer head 304 relative to the surface of the conveyor assembly 202, or relative to the surface of the food item 900. This arrangement takes into account potential variations in production of the food item 900, such as height of the food item 900. The height-adjustment assembly 312 may be configured to be operated on a manual basis or an automatic basis.

In accordance with a preferred embodiment, the apparatus 100 further includes an accumulation assembly 310 (also called an accumulation tray) configured to be positioned at a distal end section of the conveyor assembly 202. The accumulation assembly 310 is configured to receive the food item 900 from the conveyor assembly 202. Preferably, the conveyor assembly 202 includes a conveyor motor assembly 207 configured to actuate movement of the conveyor assembly 202, etc.

In accordance with an optional embodiment, and for the case where the inscribing assembly 208 does burn, at least in part, the food item 900 (once the inscribing assembly 208, in use, inscribes the outer surface 901 onto the food item 900), the apparatus 100 further includes a smoke-extraction assembly 302. The smoke-extraction assembly 302 is configured to be positioned proximate to the inscription zone 508 of the conveyor assembly 202. The smoke-extraction assembly 302 is configured to extract (remove) air with the burnt odor that is positioned proximate to the inscription zone 508 once the inscribing assembly 208, in use, burns, at least in part, the food item 900. The smoke-extraction assembly 302 may include an air filter configured to filter (remove) the burnt odor from the air that is extracted (received) from the conveyor assembly 202. The smoke-extraction assembly 302 may be called a fume extractor, etc., and any equivalent thereof. In accordance with a preferred embodiment, the smoke-extraction assembly 302 includes the LEV-CO (TRADEMARK) MODEL number WF-2 filtration system (and any equivalent thereof) and the MODEL number P-004-WFC-16 (and any equivalent thereof), and is manufactured and/or supplied by LEV-CO headquartered in Ontario, Canada.

Referring to the embodiment as depicted in FIG. 6, the apparatus 100 further includes a gear-motor assembly 314 configured to be operatively coupled to the conveyor assembly 202. The gear-motor assembly 314 is configured to regulate the operational speed of the conveyor assembly 202. Preferably, the smoke-extraction assembly 302 includes a blower assembly 303 configured to blow (move) air. Preferably, a user-control assembly 316 is configured to control operation of the control assembly 102. The user-control assembly 316 may include an emergency ON/OFF switch, etc.

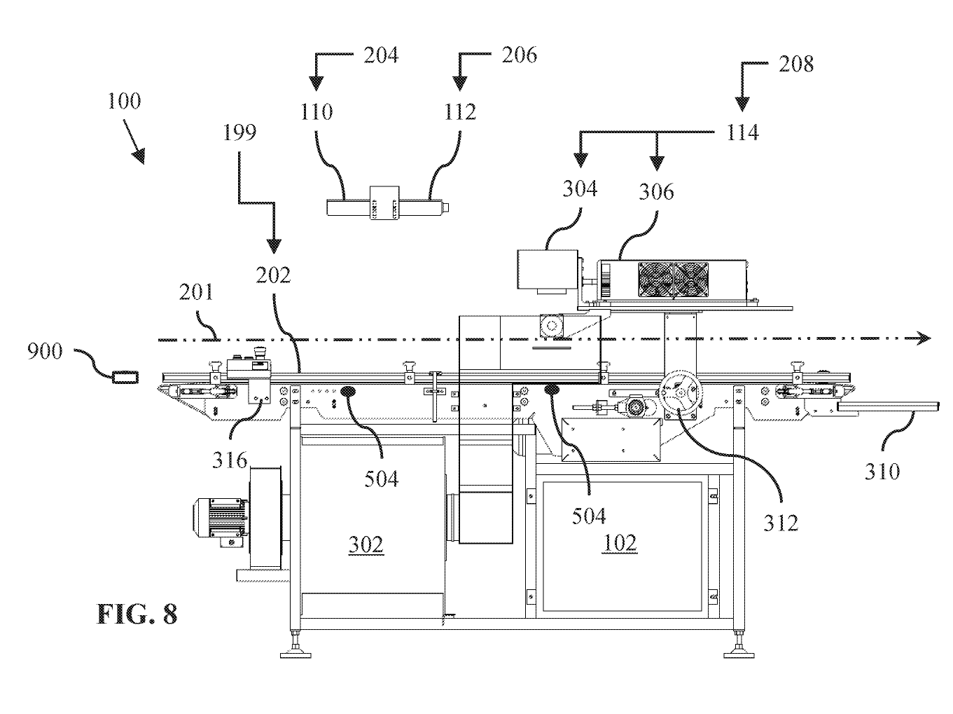

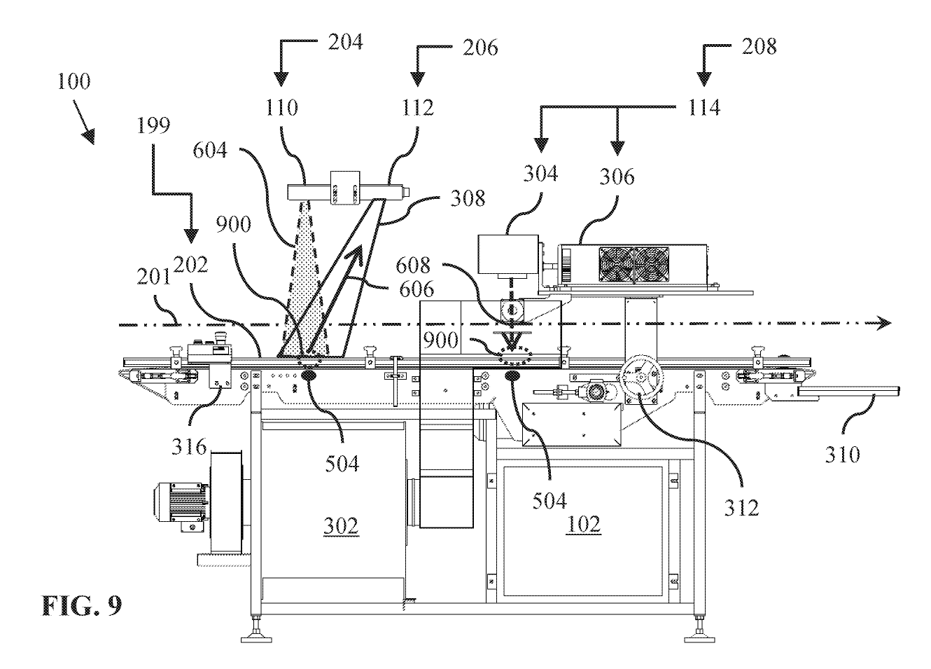

FIGS. 8 and 9 depict side views of embodiments of the apparatus 100 of FIG. 5.

Referring to the embodiment as depicted in FIG. 8, the transmitter assembly 204, the receiver assembly 206 and the inscribing assembly 208 are not activated.

Referring to the embodiment as depicted in FIG. 9, the transmitter assembly 204, the receiver assembly 206 and the inscribing assembly 208 are activated. The laser-scanner system 110 (also called a laser scanning head) is configured to emit (transmit) the emission 604. For instance, a scanning laser beam of the laser-scanner system 110 is directed toward the top surface of the conveyor assembly 202, etc. The transmitter assembly 204 includes the camera system 112 having a field of view 308 (also called a camera field of view or FOV), from which the food item 900 may be viewed by the camera system 112. The food item 900 enters the apparatus 100 from the left side of FIG. 9. The laser device of the laser-scanner system 110, in use, emits the emission 604 (such as a laser beam and/or a laser line) across the face of the food item 900 as the food item 900 is made to pass (move) past (under) the emission 604. Preferably, the emission 604 includes a stationary straight line having a dimension of about 0.020 inches wide, and preferably reaches (scans) a full width of the conveyor assembly 202 (from side-to-side). The camera system 112 (also called a scanning head camera) is configured to detect (see) a reflection of the emission 604 that is reflected from the outer surface of the food item 900. The control assembly 102 is configured to (A) receive the coordinates of the food item 900 (position and location of the food item 900) relative to the surface of the conveyor assembly 202, and (B) log (store) the coordinates in the memory assembly 104. The conveyor assembly 202 is fitted with the encoder device 116 in such a way that the position and location of the food item 900 is controlled via either a servo motor (known and not depicted) of the conveyor assembly 202, etc., or any equivalent thereof. The conveyor assembly 202 moves the food item 900 under the laser-inscribing system 114 (also called a laser etching unit), and the laser-inscribing system 114 is configured to inscribe (apply) an image to the surface of the food item 900.

Referring to an embodiment as depicted in FIG. 9, and in accordance therewith, the apparatus 100 includes (and is not limited to) the following synergistic combination of technical features: a conveyor assembly 202, an encoder device 116, a laser-scanner system 110, a camera system 112, a laser-inscribing system 114 and a control assembly 102. The conveyor assembly 202 has a conveyor belt including a working surface, in which the working surface is configured to receive and support a food item 900 having an outer surface, in such a way that the conveyor assembly 202, in use, moves the food item 900. The food item 900 is supported by the working surface. The encoder device 116 is configured to encode a position of the conveyor assembly 202. The laser-scanner system 110 is configured to cast illumination on the food item 900. The camera system 112 is configured to receive a scanned-illumination image that was cast on the food item 900 by the laser-scanner system 110. The laser-inscribing system 114 is configured to move a laser light along, at least in part, the outer surface of the food item 900. The control assembly 102 is configured to receive and tangibly store an image data unit 106 (which is depicted in FIG. 1) of an image. The image is to be formed, at least in part, by the laser light to be emitted by the laser-inscribing system 114 on the outer surface of the food item 900. The control assembly 102 is also configured to interface with and to control operations of the conveyor assembly 202. The control assembly 102 is also configured to monitor the position of the controllable movement element 203 (such as a conveyor belt) of the conveyor assembly 202 via the encoder device 116. The control assembly 102 is also configured to interface with and to control operations of the laser-scanner system 110, the camera system 112 and the laser-inscribing system 114. This is done in such a way that the control assembly 102, in use, urges the laser-inscribing system 114 to move the laser light along, at least in part, the outer surface of the food item 900. The movement of the laser light along the outer surface of the food item 900 may be performed in accordance with any one of (at least one of): (A) the graphic data file of the image that is to be formed on the food item 900 on the outer surface of the food item 900 (such as a bakery product), and (B) a geometrical property (such as, a position, a shape and/or an orientation) of the food item 900, as computed by the control assembly 102 based on the scanned-illumination image of the food item 900 that was obtained by the camera system 112 (in response to the camera system 112 receiving the reflected emission 606). The laser light, in use, forms a perceptible pattern 902 (also called a relief pattern) on the outer surface of the food item 900 while the food item 900 is supported by the controllable movement element 203 (such as a conveyor belt) of the conveyor assembly 202.

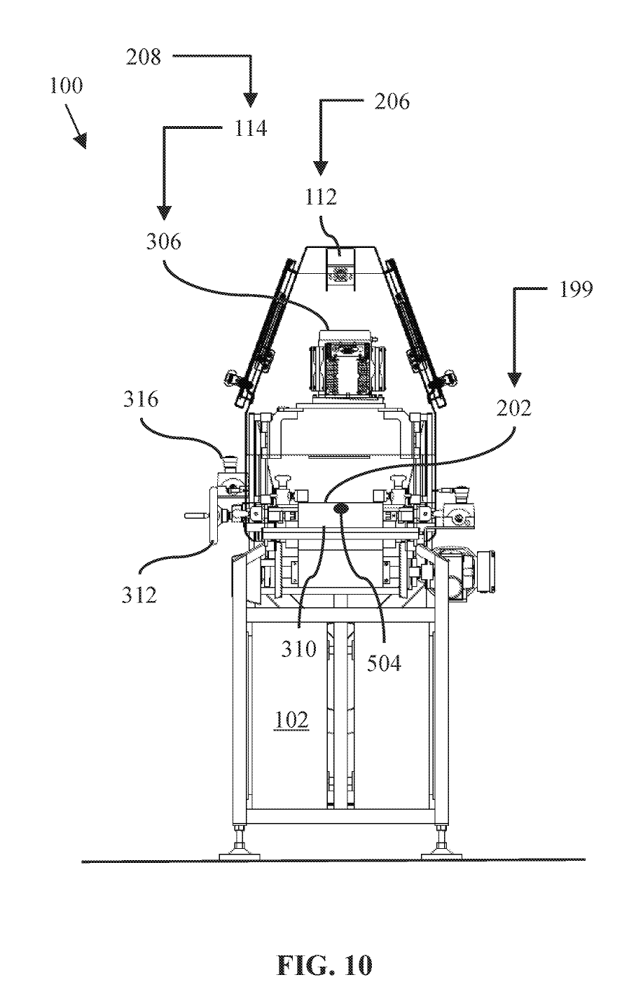

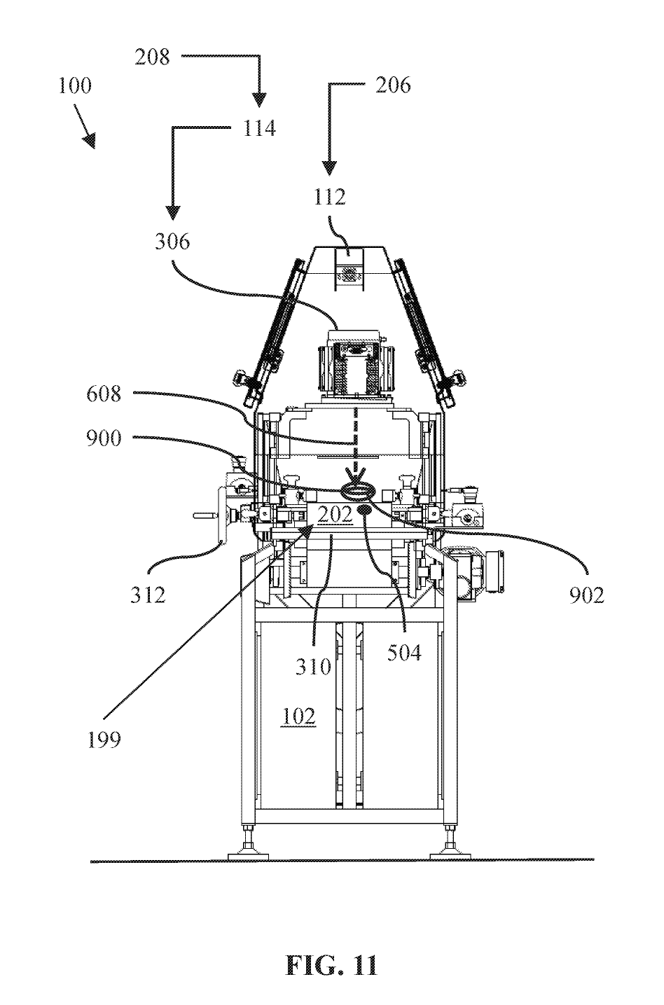

FIGS. 10 and 11 depict end views of embodiments of the apparatus 100 of FIG. 5.

Referring to the embodiment as depicted in FIG. 10, the transmitter assembly 204, the receiver assembly 206 and the inscribing assembly 208 are activated.

Referring to the embodiment as depicted in FIG. 11, the transmitter assembly 204, the receiver assembly 206 and the inscribing assembly 208 are activated.

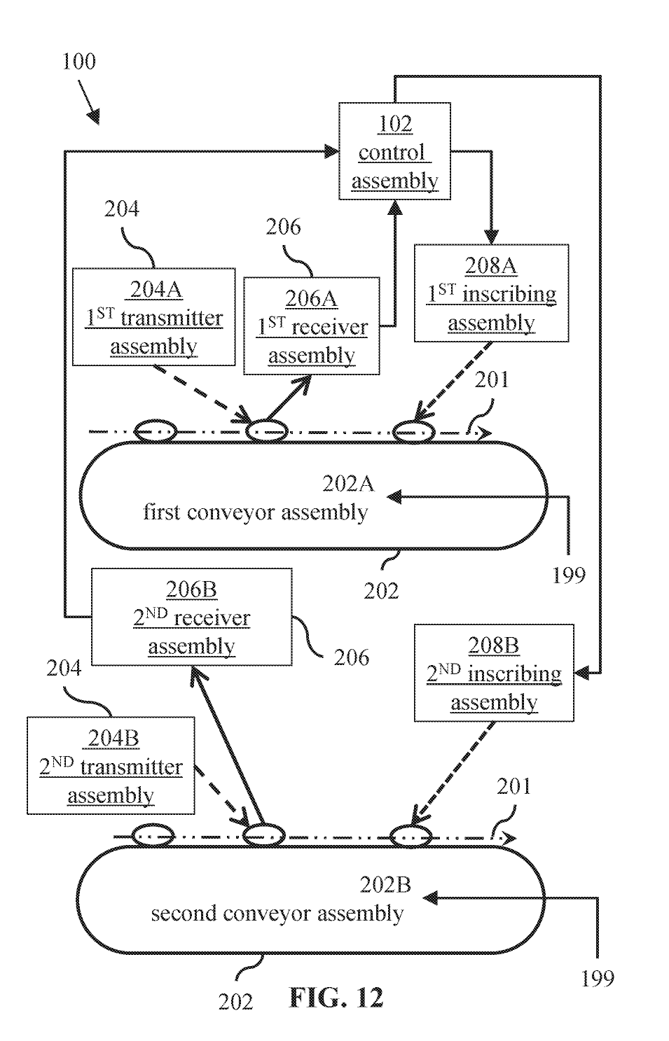

FIGS. 12, 13 and 14 depict schematic views of embodiments of the apparatus 100 of FIG. 1.

Referring to the embodiment as depicted in FIG. 12, the conveyor assembly 202 includes a first conveyor assembly 202A and a second conveyor assembly 202B that is spaced apart from the first conveyor assembly 202A. The transmitter assembly 204 includes a first transmitter assembly 204A and a second transmitter assembly 204B that is spaced apart from the first transmitter assembly 204A. The receiver assembly 206 includes a first receiver assembly 206A and a second receiver assembly 206B that is spaced apart from the first receiver assembly 206A. The inscribing assembly 208 includes a first inscribing assembly 208A and a second inscribing assembly 208B that is spaced apart from the first inscribing assembly 208A. The control assembly 102 is configured to operatively interface with (and to control operations of) the first conveyor assembly 202A, the second conveyor assembly 202B, the first transmitter assembly 204A, the second transmitter assembly 204B, the first receiver assembly 206A, the second receiver assembly 206B, the first inscribing assembly 208A and the second inscribing assembly 208B.

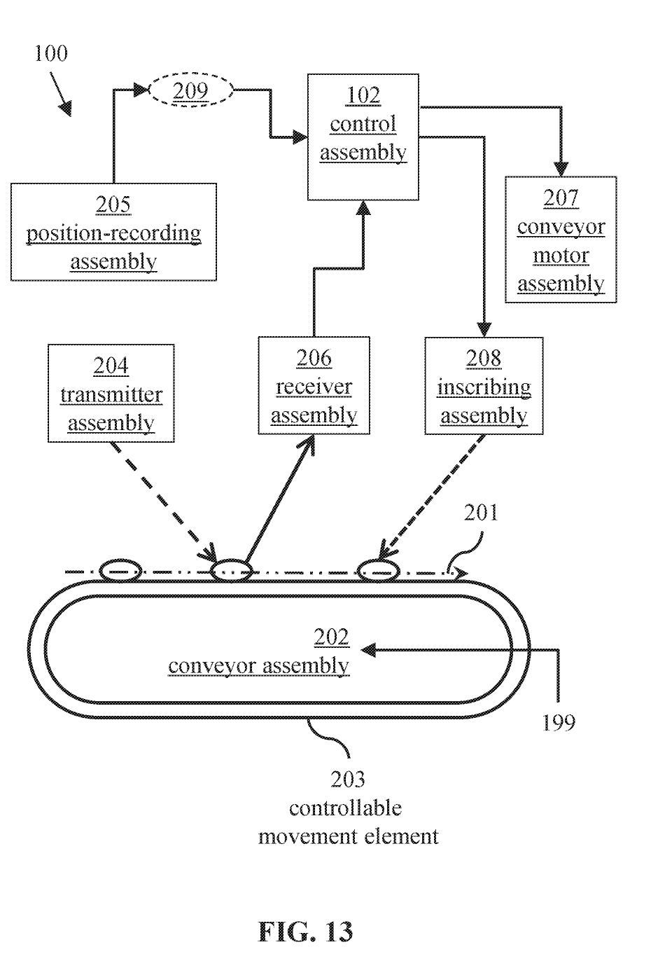

Referring to the embodiment as depicted in FIG. 13, the conveyor assembly 202 includes a controllable movement element 203 configured to receive, support and convey the food item 900 having the outer surface 901. The controllable movement element 203 may include a belt assembly, a conveyable surface, a conveyor belt, webbing material, etc., and any equivalent thereof.

The conveyor assembly 202 includes a position-recording assembly 205 (such as an encoder device 116). The position-recording assembly 205 is configured to record (encode) the position information of the controllable movement element 203 of the conveyor assembly 202. A position data unit 209 is receivable from the conveyor assembly 202. The position data unit 209 is associated with the conveyor assembly 202 (such as, the datum to be provided by an encoder device 116 associated with the conveyor assembly 202).

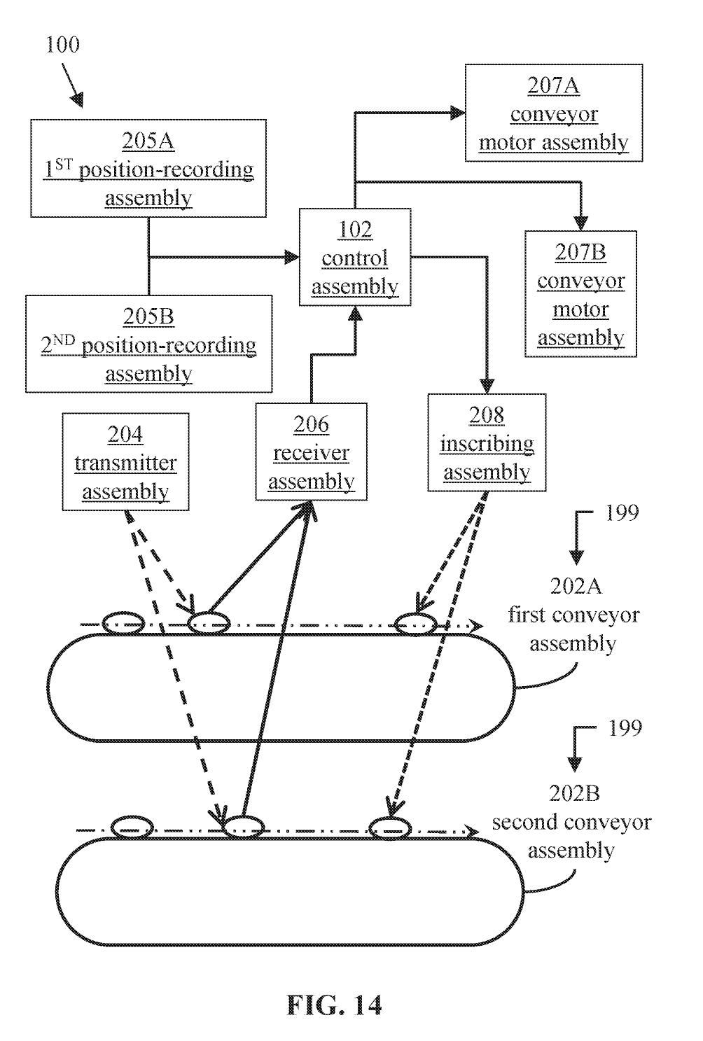

Referring to the embodiment as depicted in FIG. 14, the conveyor assembly 202 includes the first conveyor assembly 202A and the second conveyor assembly 202B. A conveyor motor assembly 207 includes (A) a first conveyor motor assembly 207A (configured to actuate movement of the first conveyor assembly 202A), and (B) a second conveyor motor assembly 207B (configured to actuate movement of the second conveyor assembly 202B). The position-recording assembly 205 includes (A) a first position-recording assembly 205A (for deployment with the first conveyor assembly 202A), and (B) a second position-recording assembly 205B (for deployment with the second conveyor assembly 202B).

The following is offered as further description of the embodiments, in which any one or more of any technical feature (described in the detailed description, the summary and the claims) may be combinable with any another one or more of any technical feature (described in the detailed description, the summary and the claims). It is understood that each claim in the claims section is an open ended claim unless stated otherwise. Unless otherwise specified, relational terms used in these specifications should be construed to include certain tolerances that the person skilled in the art would recognize as providing equivalent functionality. By way of example, the term perpendicular is not necessarily limited to 90.0 degrees, and may include a variation thereof that the person skilled in the art would recognize as providing equivalent functionality for the purposes described for the relevant member or element. Terms such as “about” and “substantially”, in the context of configuration, relate generally to disposition, location, or configuration that are either exact or sufficiently close to the location, disposition, or configuration of the relevant element to preserve operability of the element within the invention which does not materially modify the invention. Similarly, unless specifically made clear from its context, numerical values should be construed to include certain tolerances that the person skilled in the art would recognize as having negligible importance as they do not materially change the operability of the invention. It will be appreciated that the description and/or drawings identify and describe embodiments of the apparatus 100 (either explicitly or inherently). The apparatus 100 may include any suitable combination and/or permutation of the technical features as identified in the detailed description, as may be required and/or desired to suit a particular technical purpose and/or technical function. It will be appreciated that, where possible and suitable, any one or more of the technical features of the apparatus 100 may be combined with any other one or more of the technical features of the apparatus 100 (in any combination and/or permutation). It will be appreciated that persons skilled in the art would know that the technical features of each embodiment may be deployed (where possible) in other embodiments even if not expressly stated as such above. It will be appreciated that persons skilled in the art would know that other options would be possible for the configuration of the components of the apparatus 100 to adjust to manufacturing requirements and still remain within the scope as described in at least one or more of the claims. This written description provides embodiments, including the best mode, and also enables the person skilled in the art to make and use the embodiments. The patentable scope may be defined by the claims. The written description and/or drawings may help to understand the scope of the claims. It is believed that all the crucial aspects of the disclosed subject matter have been provided in this document. It is understood, for this document, that the word “includes” is equivalent to the word “comprising” in that both words are used to signify an open-ended listing of assemblies, components, parts, etc. The term “comprising”, which is synonymous with the terms “including,” “containing,” or “characterized by,” is inclusive or open-ended and does not exclude additional, unrecited elements or method steps. Comprising (comprised of) is an “open” phrase and allows coverage of technologies that employ additional, unrecited elements. When used in a claim, the word “comprising” is the transitory verb (transitional term) that separates the preamble of the claim from the technical features of the invention. The foregoing has outlined the non-limiting embodiments (examples). The description is made for particular non-limiting embodiments (examples). It is understood that the non-limiting embodiments are merely illustrative as examples.

What is claimed is:

1. An apparatus, comprising:
a positioning assembly configured to spatially position a food item; and
a receiver assembly configured to be positioned relative to the positioning assembly and the food item to be spatially positioned by the positioning assembly; and
an inscribing assembly configured to be positioned relative to the positioning assembly and the food item to be spatially positioned the positioning assembly; and
a control assembly configured to be operatively interfaced with the positioning assembly, the receiver assembly and the inscribing assembly; and
the control assembly also configured to urge the inscribing assembly to inscribe a perceptible pattern on the food item in accordance with an image data unit.

2. The apparatus of claim 1, wherein:
the positioning assembly includes a conveyor assembly, and the conveyor assembly is configured to receive and convey the food item along a direction; and
the control assembly is further configured to execute a first operation including transmitting, to the conveyor assembly, a conveyor command configured to urge the conveyor assembly to convey the food item along the direction toward an emission zone, and then to convey the food item toward an inscription zone.

3. The apparatus of claim 1, further comprising:
a transmitter assembly configured to be positioned relative to the positioning assembly and the food item to be spatially positioned by the positioning assembly; and
wherein the control assembly is further configured to be operatively interfaced with the transmitter assembly; and
wherein the control assembly is further configured to execute a second operation including transmitting, to the transmitter assembly, an emission command configured to urge the transmitter assembly to emit an emission toward the food item to be positioned at an emission zone in such a way that a reflected emission is reflected from the food item; and
wherein the control assembly is further configured to urge the inscribing assembly to inscribe the perceptible pattern on the food item in accordance with the image data unit and an output provided by the receiver assembly in cooperation with the transmitter assembly, in which the food item is to be spatially positioned by the positioning assembly.

4. The apparatus of claim 3, wherein:
the transmitter assembly includes a laser-scanner system.

5. The apparatus of claim 1, wherein:
the control assembly is further configured to execute a third operation including receiving, from the receiver assembly, an emission data unit corresponding to a reflected emission received, at least in part, by the receiver assembly in response to the receiver assembly receiving, at least in part, the reflected emission that is reflected from the food item; and
the control assembly is further configured to execute a fourth operation including transmitting, to the inscribing assembly, an inscription command configured to urge the inscribing assembly to emit an inscription emission toward the food item positioned at an inscription zone in such a way that the inscription emission, in use, inscribes the perceptible pattern on the food item in accordance with the image data unit and the emission data unit, and in which the food item is to be spatially positioned by the positioning assembly.

6. The apparatus of claim 1, wherein:
the receiver assembly includes a camera system.

7. The apparatus of claim 1, wherein:
the control assembly is further configured to execute a fourth operation including transmitting, to the inscribing assembly, an inscription command configured to urge the inscribing assembly to emit an inscription emission 60*8 toward the food item positioned at an inscription zone in such a way that the inscription emission, in use, inscribes the perceptible pattern on the food item, which is spatially positioned by the positioning assembly, in accordance with the image data unit.

8. The apparatus of claim 1, wherein:
the inscribing assembly includes a laser-inscribing system.

9. The apparatus of claim 1, further comprising:
a transmitter assembly configured to be positioned relative to the positioning assembly and the food item to be spatially positioned by the positioning assembly; and
wherein:
the control assembly is further configured to be operatively interfaced with the transmitter assembly; and
the positioning assembly includes a conveyor assembly, and the conveyor assembly is configured to receive and convey the food item along a direction; and
the control assembly is configured to be operatively interfaced with the conveyor assembly; and
the transmitter assembly is configured to be positioned relative to the conveyor assembly and the food item; and
the receiver assembly is configured to be positioned relative to the conveyor assembly and the food item; and
the inscribing assembly is configured to be positioned relative to the conveyor assembly and the food item; and
the control assembly is also configured to urge the inscribing assembly to inscribe the perceptible pattern on the food item, in which the food item was moved by the conveyor assembly, in accordance with the image data unit and an output to be provided by the receiver assembly in cooperation with the transmitter assembly; and
the control assembly is also configured to execute a first operation including transmitting, to the conveyor assembly, a conveyor command, and the conveyor command is configured to urge the conveyor assembly to (A) convey the food item along the direction toward an emission zone, and (B) convey the food item along the direction toward an inscription zone; and
the control assembly is also configured to execute a second operation including transmitting, to the transmitter assembly, an emission command, and the emission command is configured to urge the transmitter assembly to emit an emission toward the food item positioned at the emission zone in such a way that a reflected emission is reflected from the food item; and
the control assembly is also configured to execute a third operation including receiving, from the receiver assembly, an emission data unit, and the emission data unit, in use, corresponds to the reflected emission that was received, at least in part, by the receiver assembly in response to the receiver assembly receiving, at least in part, the reflected emission that is reflected from the food item; and
the control assembly is also configured to execute a fourth operation including transmitting, to the inscribing assembly, an inscription command, and the inscription command is configured to urge the inscribing assembly to emit an inscription emission toward the food item that is positioned at the inscription zone in such a way that the inscription emission, in use, inscribes the perceptible pattern on the food item in accordance with the image data unit and the emission data unit, in which the food item is receivable and conveyable by the conveyor assembly.

10. A food item, comprising:
an outer surface; and
a perceptible pattern that was inscribed, at least in part, on the outer surface by an apparatus, in which the apparatus includes:
a positioning assembly configured to spatially position the food item; and
a receiver assembly configured to be positioned relative to the positioning assembly and the food item to be spatially positioned by the positioning assembly; and
an inscribing assembly configured to be positioned relative to the positioning assembly and the food item to be spatially positioned the positioning assembly; and
a control assembly configured to be operatively interfaced with the positioning assembly, the receiver assembly and the inscribing assembly; and
the control assembly also configured to urge the inscribing assembly to inscribe the perceptible pattern on the food item in accordance with an image data unit.

11. The food item of claim 10, wherein:
the positioning assembly includes a conveyor assembly, and the conveyor assembly is configured to receive and convey the food item along a direction; and
the control assembly is further configured to execute a first operation including transmitting, to the conveyor assembly, a conveyor command configured to urge the conveyor assembly to convey the food item along the direction toward an emission zone, and then to convey the food item toward an inscription zone.

12. The food item of claim 10, wherein:
the apparatus further includes a transmitter assembly configured to be positioned relative to the positioning assembly and the food item to be spatially positioned by the positioning assembly; and
the control assembly is further configured to be operatively interfaced with the transmitter assembly; and
wherein the control assembly is further configured to execute a second operation including transmitting, to the transmitter assembly, an emission command configured to urge the transmitter assembly to emit an emission toward the food item to be positioned at an emission zone in such a way that a reflected emission is reflected from the food item; and
wherein the control assembly is further configured to urge the inscribing assembly to inscribe the perceptible pattern on the food item in accordance with the image data unit and an output provided by the receiver assembly in cooperation with the transmitter assembly, in which the food item is to be spatially positioned by the positioning assembly.

13. The food item of claim 12, wherein:
the transmitter assembly includes a laser-scanner system; and
the receiver assembly includes a camera system; and
the inscribing assembly includes a laser-inscribing system.

14. The food item of claim 10, wherein:
the control assembly is further configured to execute a third operation including receiving, from the receiver assembly, an emission data unit corresponding to a reflected emission received, at least in part, by the receiver assembly in response to the receiver assembly receiving, at least in part, the reflected emission that is reflected from the food item; and
the control assembly is further configured to execute a fourth operation including transmitting, to the inscribing assembly, an inscription command configured to urge the inscribing assembly to emit an inscription emission toward the food item positioned at an inscription zone in such a way that the inscription emission, in use, inscribes the perceptible pattern on the food item in accordance with the image data unit and the emission data unit, and in which the food item is to be spatially positioned by the positioning assembly.

15. The apparatus of claim 10, wherein:
the control assembly is further configured to execute a fourth operation including transmitting, to the inscribing assembly, an inscription command configured to urge the inscribing assembly to emit an inscription emission toward the food item positioned at an inscription zone in such a way that the inscription emission, in use, inscribes the perceptible pattern on the food item, which is spatially positioned by the positioning assembly, in accordance with the image data unit.

16. The food item of claim 10, wherein:
the apparatus further includes a transmitter assembly configured to be positioned relative to the positioning assembly and the food item to be spatially positioned by the positioning assembly; and
the control assembly is further configured to be operatively interfaced with the transmitter assembly; and
the positioning assembly includes a conveyor assembly, and the conveyor assembly is configured to receive and convey the food item along a direction; and
the control assembly is configured to be operatively interfaced with the conveyor assembly; and
the transmitter assembly is configured to be positioned relative to the conveyor assembly and the food item; and
the receiver assembly is configured to be positioned relative to the conveyor assembly and the food item; and
the inscribing assembly is configured to be positioned relative to the conveyor assembly and the food item; and
the control assembly is also configured to urge the inscribing assembly to inscribe the perceptible pattern on the food item, in which the food item was moved by the conveyor assembly, in accordance with the image data unit and an output to be provided by the receiver assembly in cooperation with the transmitter assembly; and
the control assembly is also configured to execute a first operation including transmitting, to the conveyor assembly, a conveyor command, and the conveyor command is configured to urge the conveyor assembly to (A) convey the food item along the direction toward an emission zone, and (B) convey the food item along the direction toward an inscription zone; and
the control assembly is also configured to execute a second operation including transmitting, to the transmitter assembly, an emission command, and the emission command is configured to urge the transmitter assembly to emit an emission toward the food item positioned at the emission zone in such a way that a reflected emission is reflected from the food item; and
the control assembly is also configured to execute a third operation including receiving, from the receiver assembly, an emission data unit, and the emission data unit, in use, corresponds to the reflected emission that was received, at least in part, by the receiver assembly in response to the receiver assembly receiving, at least in part, the reflected emission that is reflected from the food item; and
the control assembly is also configured to execute a fourth operation including transmitting, to the inscribing assembly, an inscription command, and the inscription command is configured to urge the inscribing assembly to emit an inscription emission toward the food item that is positioned at the inscription zone in such a way that the inscription emission, in use, inscribes the perceptible pattern on the food item in accordance with the image data unit and the emission data unit, in which the food item is receivable and conveyable by the conveyor assembly.

17. An apparatus, comprising:
a memory assembly configured to tangibly store an executable program including coded instructions configured to be readable and executable by a control assembly, and the executable program configured to urge the control assembly to perform predetermined controller operations; and
the memory assembly also configured to be operatively interfaced with the control assembly; and
wherein:
the control assembly is configured to be operatively interfaced with a positioning assembly, a receiver assembly and an inscribing assembly; and
the positioning assembly is configured to spatially position a food item the receiver assembly is configured to be positioned relative to the positioning assembly and the food item to be spatially positioned by the positioning assembly; and
the inscribing assembly is configured to be positioned relative to the positioning assembly and the food item to be spatially positioned the positioning assembly; and
the executable program is configured to urge the control assembly to urge the inscribing assembly to inscribe a perceptible pattern on the food item in accordance with an image data unit.

18. The apparatus of claim 17, wherein:
a transmitter assembly is configured to be positioned relative to the positioning assembly and the food item to be spatially positioned by the positioning assembly; and
the control assembly is further configured to be operatively interfaced with the transmitter assembly; and
the executable program is configured to urge the control assembly to transmit, to the transmitter assembly, an emission command configured to urge the transmitter assembly to emit an emission toward the food item to be positioned at an emission zone in such a way that a reflected emission is reflected from the food item; and
the executable program is configured to urge the control assembly to urge the inscribing assembly to inscribe the perceptible pattern on the food item in accordance with the image data unit and an output provided by the receiver assembly in cooperation with the transmitter assembly, in which the food item is to be spatially positioned by the positioning assembly.

19. The apparatus of claim 17, wherein:
the executable program is configured to urge the control assembly to receive, from the receiver assembly, an emission data unit corresponding to a reflected emission received, at least in part, by the receiver assembly in response to the receiver assembly receiving, at least in part, the reflected emission that is reflected from the food item; and
the executable program is configured to urge the control assembly to transmit, to the inscribing assembly, an inscription command configured to urge the inscribing assembly to emit an inscription emission toward the food item positioned at an inscription zone in such a way that the inscription emission, in use, inscribes the perceptible pattern on the food item in accordance with the image data unit and the emission data unit, and in which the food item is to be spatially positioned by the positioning assembly.

20. The apparatus of claim 17, wherein:
a transmitter assembly is configured to be positioned relative to the positioning assembly and the food item to be spatially positioned by the positioning assembly; and
the control assembly is further configured to be operatively interfaced with the transmitter assembly; and
the positioning assembly includes a conveyor assembly, and the conveyor assembly is configured to receive and convey the food item along a direction; and
the control assembly is configured to be operatively interfaced with the conveyor assembly; and
the transmitter assembly is configured to be positioned relative to the conveyor assembly and the food item; and
the receiver assembly is configured to be positioned relative to the conveyor assembly and the food item; and
the inscribing assembly is configured to be positioned relative to the conveyor assembly and the food item; and
the executable program is configured to urge the control assembly to urge the inscribing assembly to inscribe the perceptible pattern on the food item, in which the food item was moved by the conveyor assembly, in accordance with the image data unit and an output to be provided by the receiver assembly in cooperation with the transmitter assembly; and
the executable program is configured to urge the control assembly to transmit, to the conveyor assembly, a conveyor command, and the conveyor command is configured to urge the conveyor assembly to (A) convey the food item along the direction toward an emission zone, and (B) convey the food item along the direction toward an inscription zone; and
the executable program is configured to urge the control assembly to transmit, to the transmitter assembly, an emission command, and the emission command is configured to urge the transmitter assembly to emit an emission toward the food item positioned at the emission zone in such a way that a reflected emission is reflected from the food item; and
the executable program is configured to urge the control assembly to receive, from the receiver assembly, an emission data unit, and the emission data unit, in use, corresponds to the reflected emission that was received, at least in part, by the receiver assembly in response to the receiver assembly receiving, at least in part, the reflected emission that is reflected from the food item; and
the executable program is configured to urge the control assembly to transmit, to the inscribing assembly, an inscription command, and the inscription command is configured to urge the inscribing assembly to emit an inscription emission toward the food item that is positioned at the inscription zone in such a way that the inscription emission, in use, inscribes the perceptible pattern on the food item in accordance with the image data unit and the emission data unit, in which the food item is receivable and conveyable by the conveyor assembly.
